(19) United States
(12) Patent Application Publication
(10) Pub. No.: US 2007/0048573 A1
(43) Pub. Date: Mar. 1, 2007

(54) Direct-flame-exposure-type fuel-cell power generating apparatus

(76) Inventors: Shigeaki Suganuma, Nagano-shi (JP); Yasue Tokutake, Nagano-shi (JP); Fumimasa Katagiri, Nagano-shi (JP); Michio Horiuchi, Nagano-shi (JP)

Correspondence Address: MORGAN & FINNEGAN, L.L.P., 3 WORLD FINANCIAL CENTER, NEW YORK, NY, 10281-2101, US

(21) Appl. No.: 11/396,204

(22) Filed: Mar. 30, 2006

(30) Foreign Application Priority Data
Aug. 29, 2005 (JP) 2005-248176

(51) Int. Cl. H01M 8/04; H01M 8/12

(52) U.S. Cl. 429/26; 429/30

(57) ABSTRACT

In a direct-flame-exposure-type fuel-cell power generating apparatus according to the present invention, a flame produced by burning a mixture gas of a fuel gas and air is supplied to an anode electrode layer, and the supply condition of the flame is adjusted in a mixture gas generating device. The temperature rising or falling speed of a solid oxide fuel cell can be adjusted by adjusting the mixture ratio and thereby changing the condition of the flame when starting or stopping the operation of the fuel cell power generation. The flame supply condition can also be adjusted by changing the spacing between the solid oxide fuel cell and a gas-fired burner.

### CROSS-REFERENCE TO RELATED APPLICATION

This application claims the priority of Japanese Patent Application Number 2005-248176, filed on Aug. 29, 2005.

### BACKGROUND OF THE INVENTION

1. Field of the Invention

The present invention relates to a power generating apparatus that generates power by using a solid oxide fuel cell to which a flame is directly supplied, and more particularly to a direct-flame-exposure-type fuel-cell power generating apparatus that is adapted to be able to adjust the condition of the flame to be supplied to the solid oxide fuel cell, thereby aiming not only to enhance the power generation performance of the fuel cell but also to mitigate thermal shock to the solid oxide fuel cell, thereby preventing cracks from occurring in the fuel cell.

2. Description of the Related Art

The fuel cells so far developed can be classified into various types according to the method of power generation. One type is a fuel cell that uses a solid electrolyte. In one example of the fuel cell that uses a solid electrolyte, a calcined structure made of yttria (Y₂O₃)-doped stabilized zirconia is used as an oxygen ion conducting solid oxide substrate. This fuel cell comprises a cathode electrode layer formed on one surface of the solid oxide substrate and an anode electrode layer on the opposite surface thereof, and oxygen or an oxygen-containing gas is supplied to the cathode electrode layer, while a fuel gas such as methane is supplied to the anode electrode layer.

In this fuel cell, the oxygen (O₂) supplied to the cathode electrode layer is converted into oxygen ions (O²⁻) at the boundary between the cathode electrode layer and the solid oxide substrate, and the oxygen ions are conducted through the solid oxide substrate into the anode electrode layer where the ions react with the fuel gas, for example, a methane gas (CH₄), supplied to the anode electrode layer, producing water (H₂O), carbon dioxide (CO₂), hydrogen (H₂), and carbon monoxide (CO). In this reaction process, the oxygen ions release electrons, and a potential difference therefore occurs between the cathode electrode layer and the anode electrode layer. Here, when lead wires are attached to the cathode electrode layer and the anode electrode layer, the electrons in the anode electrode layer flow into the cathode electrode layer via the lead wires, and the fuel cell thus generates electric power. The operating temperature of this fuel cell is about 1000° C.

However, this type of fuel cell requires the provision of separate chambers, one being an oxygen or oxygen-containing gas supply chamber on the cathode electrode layer side and the other a fuel gas supply chamber on the anode electrode layer side; furthermore, as the fuel cell is exposed to oxidizing and reducing atmospheres at high temperatures, it has been difficult to increase the durability of the fuel cell.

On the other hand, there has been developed a fuel cell of the type that comprises a cathode electrode layer and an anode electrode layer formed on opposite surfaces of a solid oxide substrate, and that generates an electromotive force between the cathode electrode layer and the anode electrode layer by placing the fuel cell in a fuel gas mixture consisting of a fuel gas, for example, a methane gas, and oxygen. The principle of generating an electromotive force between the cathode electrode layer and the anode electrode layer is the same for this type of fuel cell as for the above-described separate-chamber type fuel cell but, as the entire fuel cell can be exposed to substantially the same atmosphere, the fuel cell can be constructed as a single-chamber type cell into which the fuel gas mixture is supplied, and this serves to increase the durability of the fuel cell.

However, in this single-chamber fuel cell, as the fuel cell has to be operated at a high temperature of about 1000° C., there is the danger that the fuel gas mixture may explode. If the oxygen concentration is reduced to a level lower than the ignitability limit to avoid such danger, there occurs the problem that carbonization of the fuel, such as methane, progresses and the fuel cell performance degrades. In view of this, there has been developed a single-chamber fuel cell that can use a fuel gas mixture whose oxygen concentration is adjusted so as to be able to prevent the progress of carbonization of the fuel, while at the same time, preventing an explosion of the fuel gas mixture.

The fuel cell so far described is of the type that is constructed by housing the fuel cell in a chamber having a hermetically sealed structure; on the other hand, there has been proposed an apparatus that generates power by placing a solid oxide fuel cell in or near a flame and thereby holding the solid oxide fuel cell at its operating temperature.

The fuel cell used in the above-proposed power generating apparatus comprises a zirconia solid oxide substrate formed in a tubular structure, a cathode electrode layer as an air electrode formed on the inner circumference of the tubular structure, and an anode electrode layer as a fuel electrode formed on the outer circumference of the tubular structure. This solid oxide fuel cell using the solid electrolyte is placed with the anode electrode layer exposed to a reducing portion of a flame generated by a combustion device to which the fuel gas is supplied. In this arrangement, radicals, etc. present in the reducing flame can be utilized as the fuel, while air is supplied by convection or diffusion to the cathode electrode layer inside the tubular structure, and the solid oxide fuel cell can thus generate electric power.

The earlier described single-chamber fuel-cell obviates the necessity of strictly separating the fuel and the air as was the case with conventional solid oxide fuel cells, but instead has to employ a hermetically sealed construction. Further, to increase the electromotive force, a plurality of flat plate solid oxide fuel cells are stacked one on top of another and connected together using an interconnecting material having high heat resistance and high electrical conductivity so as to be able to operate at high temperatures. As a result, the single-chamber fuel-cell device constructed from a stack of flat plate solid oxide fuel cells has the problem that the construction is not only large but also costly.

Furthermore, in operation, the temperature is gradually raised to the high operating temperature in order to prevent cracking of the solid oxide fuel cells; therefore, the single-chamber fuel-cell device requires a significant startup time, thus causing extra trouble.

In contrast, the above-proposed solid oxide fuel cell of tubular structure employs a construction that directly utilizes a flame; this type of fuel cell has the characteristic of being an open type, the solid electrolyte fuel cell not needing to be housed in a hermetically sealed container. As a result, this type of fuel cell can reduce the startup time, is simple in structure, and is therefore advantageous when it comes to reducing the size, weight, and cost of the fuel cell. Further, as the flame is used directly, this type of fuel cell can be incorporated in a conventional combustion apparatus or an incinerator or the like, and is thus expected to be used as a power supply apparatus.

However, in this type of fuel cell, as the anode electrode layer is formed on the outer circumference of the tubular solid oxide substrate, radicals due to the flame are not supplied, in particular, to the lower half of the anode electrode layer, and effective use cannot be made of the entire surface of the anode electrode layer formed on the outer circumference of the tubular solid oxide substrate. This has degraded the power generation efficiency. There has also been the problem that, as the solid oxide fuel cell is directly and unevenly heated by the flame, cracking tends to occur due to rapid changes in temperature.

In view of the above situation, Japanese Unexamined Patent Publication No. 2004-139936, for example, proposes a power generating apparatus using a solid oxide fuel cell as a handy power supply means, wherein improvements in durability and power generation efficiency and reductions in size and cost are achieved by employing a solid oxide fuel cell of the type that directly utilizes a flame produced by burning a fuel, and by making provisions to apply the flame over the entire surface of the anode electrode layer formed on a flat plate solid oxide substrate.

As described above, the previously proposed solid-oxide fuel-cell power generating apparatus requires, in the case of the chamber type, the provision of an electric oven for heating the solid oxide fuel cell to its operating temperature and a supply device for supplying a fuel gas and oxygen or air; as a result, the apparatus itself is complex and large in construction, and the apparatus as a power generating apparatus has not been of the type that persons can carry around.

On the other hand, the previously proposed power generating apparatus using the solid oxide fuel cell that directly utilizes a flame requires the provision of a combustion device for producing a flame by burning a fuel, but has the advantage that a small, compact, and light-weight power generating apparatus can be achieved because a candle, a lighter, or another handy device, that can produce a flame, can be used as the combustion device.

However, while power can be easily generated using the flame produced by the combustion device, this type of power generating apparatus has had the problem that, because of the ease with which the combustion device is turned on and off, the amount of heat supplied to the solid oxide fuel cell changes abruptly and this abrupt change causes thermal shock to the solid oxide fuel cell, inducing cracks in the solid oxide structure. Furthermore, the traditionally used combustion device has had a problem in terms of stable power generation, because flame fluctuations, etc. occur and the supply of the flame becomes unstable or the formation of the flame cannot be adjusted to a condition desirable for the power generating operation of the solid oxide fuel cell.

It is accordingly an object of the present invention to provide a power generating apparatus using a direct-flame-exposure-type solid oxide fuel cell wherein the supply condition of the flame to be supplied to the solid oxide fuel cell is adjusted so as to maintain the solid oxide fuel cell in an optimum power generating condition so that power can be generated stably, and wherein, when starting or stopping the power generating operation, the flame supply from the combustion device is adjusted so as to mitigate thermal shock to the solid oxide fuel cell, thereby preventing cracks from occurring in the solid oxide fuel cell.

### SUMMARY OF THE INVENTION

To solve the above problems, a direct-flame-exposure type-fuel-cell power generating apparatus according to the present invention comprises: a solid oxide fuel cell having a solid oxide substrate, a cathode electrode layer formed on one surface of the substrate, and an anode electrode layer formed on a surface of the substrate opposite to the one surface; and a flame producing device which can supply the anode electrode layer with a flame produced by combustion of a premixed gas, and can adjust the supply condition of the flame, wherein the solid oxide fuel cell generates power by using oxygen or an oxygen-containing gas supplied to the cathode electrode layer and components of the flame supplied from the flame producing device to the anode electrode layer.

The flame producing device is connected to a gas generating device which generates the premixed gas from a fuel gas and oxygen or an oxygen-containing gas; more particularly, the flame producing device is equipped with an opening adjuster for adjusting an opening for the gas combustion so that the flow velocity of the premixed gas to be discharged can be changed by operating the opening adjuster so as to vary the combustion opening.

The solid oxide fuel cell is supported on a base that can adjust spacing between the solid oxide fuel cell and the flame producing device.

Further, the gas generating device can generate the premixed gas by varying a mixture ratio between the fuel gas and the oxygen-containing gas; more particularly, when the power generation is started, the gas generating device generates the premixed gas by gradually increasing the ratio of the oxygen-containing gas and, when the solid oxide fuel cell has reached a prescribed condition, the gas generating device generates the premixed gas at a prescribed mixture ratio, while on the other hand, when stopping the power generation, the gas generating device generates the premixed gas by gradually increasing the ratio of the oxygen-containing gas to the fuel gas compared with the prescribed mixture ratio, and stops supply of the fuel gas.

Further, the gas generating device is equipped with a gas buffer tank communicating with the flame producing device and, when the power generation is started, the gas generating device first supplies the oxygen-containing gas in a specified amount to the gas buffer tank and then supplies the fuel gas in a specified amount to the gas buffer tank, thereby supplying the flame producing device first with a premixed gas whose fuel gas density is lower than a specified density and then with a premixed gas at a prescribed mixture ratio.

The gas generating device is equipped with a gas buffer tank communicating with the flame producing device and, when stopping the power generation, the gas generating device first stops supply of the fuel gas to the gas buffer tank and, when the density of the fuel gas in the premixed gas supplied to the gas buffer tank has dropped below a combustion limit of the premixed gas, then stops supply of the oxygen-containing gas to the gas buffer tank.

As described above, the direct-flame-exposure-type fuel-cell power generating apparatus according to the present invention comprises the solid oxide fuel cell, which includes the solid oxide substrate, the cathode electrode layer formed on one surface of the substrate, and the anode electrode layer formed on the surface of the substrate opposite from the one surface, and the flame producing device, which can supply the anode electrode layer with a flame produced by combustion of a premixed gas, and can adjust the supply condition of the flame. With this construction, the producing condition of the flame to be applied to the solid oxide fuel cell can be changed by adjusting the flow velocity of the mixture gas supplied to the gas-fired burner or by adjusting the fuel density, or alternatively by adjusting the spacing between the solid oxide fuel cell and the gas-fired burner

Accordingly, not only can the power generation output of the fuel cell be adjusted, but also the temperature rising or falling speed of the solid oxide fuel cell can be easily adjusted when starting or stopping the power generating operation of the fuel cell; as a result, the thermal shock that occurs in the solid oxide fuel cell can be mitigated, and the possibility of the occurrence of cracks, delamination at the interface within the fuel cell, etc. can thus be reduced.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a diagram for explaining an embodiment of a power generating apparatus according to the present invention in which a solid oxide fuel cell is used as a direct-flame-exposure-type fuel cell;

FIG. 2 is a diagram for explaining how the output of the solid oxide fuel cell changes when the flow velocity of a mixture gas discharged from a gas-fired burner is changed;

FIG. 3 is a diagram for explaining a power generating apparatus according to an another embodiment in which the solid oxide fuel cell is used as the direct-flame type fuel cell;

FIG. 4 is a diagram for explaining a power generating apparatus which can adjust the spacing between the solid oxide fuel cell and the gas-fired burner; and

FIG. 5 is a diagram for explaining how electric power is generated by the solid oxide fuel cell by directly using a gas-fired flame as a fuel.

### DESCRIPTION OF THE PREFERRED EMBODIMENTS

Embodiments of a direct-flame-exposure-type fuel-cell power generating apparatus according to the present invention will be described below with reference to the drawings. However, before proceeding to the description of the direct-flame-exposure-type solid-oxide fuel-cell power generating apparatus of the present embodiments, a previously proposed direct-flame-exposure type-solid-oxide fuel-cell power generating apparatus will be described in order to clarify the features and advantages of the present embodiments.

FIG. 5 shows the previously proposed solid-oxide fuel-cell power generating apparatus. The solid oxide fuel cell C used in the power generating apparatus shown in FIG. 5 comprises a flat plate solid oxide substrate 1 circular or rectangular in shape, a cathode electrode layer 2 as an air electrode (oxygen electrode) formed on one surface of the substrate, and an anode electrode layer 3 as a fuel electrode formed on the opposite surface thereof. The cathode electrode layer 2 and the anode electrode layer 3 are disposed in such a manner as to face each other with the solid oxide substrate 1 interposed therebetween.

The power generating apparatus is constructed using the thus constructed solid oxide fuel cell C; more specifically, the fuel cell C with the anode electrode layer 3 facing down is placed above a gas-fired burner 4 to which a fuel gas is supplied, and power is generated by directly exposing the anode electrode layer 3 to a flame f formed by the combustion of the fuel gas. A fuel that burns and oxidizes by forming a flame is supplied as the fuel to the gas-fired burner 4. As the fuel, phosphorus, sulfur, fluorine, chlorine, or their compounds may be used, but an organic substance that does not need exhaust gas treatment is preferable. Such organic fuels include, for example, gases such as methane, ethane, propane, and butane, gasoline-based liquids such as hexane, heptane, octane, alcohols such as methanol, ethanol, and propanol, ketons such as acetone, and various other organic solvents, edible oil, kerosene, paper, wood, etc. Of these fuels, a gaseous fuel is particularly preferable.

Further, the flame may be a diffusion flame or a premixed gas combustion flame, but the premixed gas combustion flame is preferred for use, because the diffusion flame is unstable and tends to incur degradation of the performance of the anode electrode layer due to the production of soot. The premixed gas combustion flame is not only stable but the flame size is easily adjustable; in addition, the production of soot can be prevented by adjusting the fuel density.

As the solid oxide fuel cell C is formed in a flat plate shape, the flame f produced by the combustion device 4 can be applied uniformly over the anode electrode layer 3 of the solid oxide fuel cell C; that is, compared with the tubular type, the flame f can be applied evenly. Furthermore, with the anode electrode layer 3 disposed facing the flame f, hydrocarbons, hydrogen, radicals (OH, CH, C₂, O₂H, CH₃), etc. present in the flame can be easily utilized as the fuel to generate power based on the oxidation-reduction reaction. Further, the cathode electrode layer 2 is exposed to an oxygen-containing gas, for example, air, making it easier to utilize the oxygen from the cathode electrode layer 2; here, if provisions are made to blow the oxygen-containing gas toward the cathode electrode layer 2, the cathode electrode layer can be maintained in an oxygen-rich condition more efficiently.

The power generated by the solid oxide fuel cell C is taken between the lead wires L1 and L2 brought out from the cathode electrode layer 2 and the anode electrode layer 3, respectively. For the lead wires L1 and L2, platinum or a platinum-containing alloy is used.

In view of the above, in the power generating apparatus using the direct-flame-exposure-type solid oxide fuel cell according to the present invention, the supply condition of the flame to be supplied to the solid oxide fuel cell is adjusted so as to maintain the solid oxide fuel cell in an optimum power generating condition so that power can be generated stably; further, provisions are made so that the flame to be supplied from the combustion device can be adjusted when starting or stopping the power generating operation.

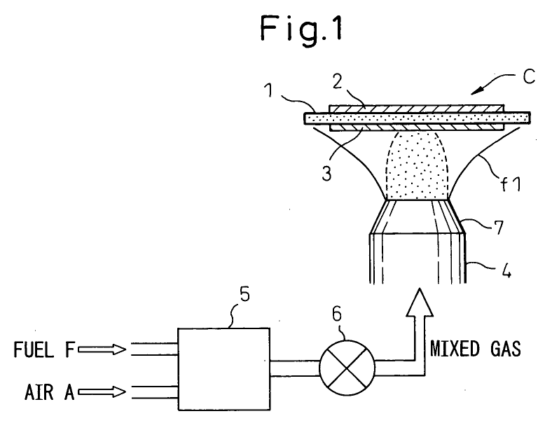

Next, the embodiments of the direct-flame-exposure-type fuel-cell power generating apparatus according to the present invention will be described with reference to FIGS. 1 to 3. However, before proceeding to the description of the power generating apparatus of the present embodiments, the solid oxide fuel cell used in the power generating apparatus will be described below.

The structure of the solid oxide fuel cell used in the present embodiments is basically the same as that of the solid oxide fuel cell C shown in FIG. 5, and comprises a solid oxide substrate 1, a cathode electrode layer 2, and an anode electrode layer 3.

The solid oxide substrate 1 is, for example, a flat rectangular plate, and the cathode electrode layer 2 and the anode electrode layer 3 are respectively formed over almost the entire surface of each side of the flat solid oxide substrate 1 in such a manner as to face each other with the solid oxide substrate 1 interposed therebetween. A lead wire L1 is connected to the cathode electrode layer 2 and a lead wire L2 to the anode electrode layer 3, and the fuel cell output is taken between the lead wires L1 and L2. The solid oxide substrate 1 need only be formed in a plate-like shape, and need not be limited to the rectangular shape but can be formed in any suitable shape as long as it is shaped so as to be exposed to the premixed gas combustion flame produced by the gas-fired burner of the combustion device; for example, the substrate can be formed in a circular shape.

For the solid oxide substrate 1, known materials can be used, examples including the following:

a) YSZ (yttria-stabilized zirconia), ScSZ (scandia-stabilized zirconia), and zirconia-based ceramics formed by doping these materials with Ce, Al, etc.

b) SDC (samaria-doped ceria), GDC (gadolinium-doped ceria), and other ceria-based ceramics.

c) LSGM (lanthanum gallate) and bismuth oxide-based ceramics.

For the anode electrode layer 3, known materials can be used, examples including the following:

d) Cermet of nickel and a ceramic based on yttria-stabilized zirconia or scandia-stabilized zirconia or a ceramic based on ceria (SDC, GDC, YDC, etc.).

e) Sintered material composed principally of electrically conductive oxide (50% to 99% by weight) (electrically conductive oxide is, for example, nickel oxide containing lithium in solid solution).

f) Material given in d) or e) to which a metal made of a platinum-group metallic element or its oxide is added in an amount of about 1% to 10% by weight.

Of these materials, d) and e) are particularly preferable.

The sintered material composed principally of electrically conductive oxide given in e) has excellent oxidation resistance, and therefore, can prevent phenomena, resulting from the oxidation of the anode electrode layer, such as delamination of the anode electrode layer from the solid oxide layer and degradation of power generation efficiency or inability to generate power due to the rise in the electrode resistance of the anode electrode layer. For the electrically conductive oxide, nickel oxide containing lithium in solid solution is preferable. It will also be noted that a higher power generation performance can be obtained by adding a metal made of a platinum-group element or its oxide to the material given in d) or e).

For the cathode electrode layer, known materials, which contain an element, such as lanthanum, selected from group III of the periodic table and doped with strontium (Sr), can be used, and examples include a manganic acid compound (for example, lanthanum strontium manganite), a gallium acid compound and a cobalt acid compound (for example, lanthanum strontium cobaltite).

The cathode electrode layer 2 and the anode electrode layer 3 are both formed in a porous structure. For these electrode layers, the porosity of the porous structure should be set to 20% or higher, preferably 30 to 70%, and more preferably 40 to 50%. In the solid oxide fuel cell used in the present embodiments, the cathode electrode layer 2 and the anode electrode layer 3 are both formed in a porous structure, thereby making it easier to supply the oxygen in the air over the entire surface of the interface between the cathode electrode layer 2 and the solid oxide substrate 1 and also making it easier to supply the fuel over the entire surface of the interface between the anode electrode layer 3 and the solid oxide substrate 1.

The solid oxide substrate 1 also can be formed in a porous structure. If the solid oxide substrate were formed in a closely compacted structure, its thermal shock resistance would drop, and the substrate would easily tend to crack when subjected to rapid temperature changes. Furthermore, as the solid oxide substrate is generally formed thicker than the anode electrode layer and the cathode electrode layer, any crack occurring in the solid oxide substrate would lead to the formation of cracks in the entire structure of the solid oxide fuel cell which would eventually disintegrate.

The solid oxide fuel cell C is fabricated, for example, in the following manner. First, powders of materials for forming the solid oxide substrate are mixed in prescribed proportions, and the mixture is molded into a flat plate shape. After that, the flat plate-like structure is calcined and sintered to produce the solid oxide layer which serves as the substrate. Here, by adjusting the kinds and proportions of the powder materials including a pore-forming agent and the calcination conditions such as calcination temperature, calcination time, preliminary calcination, etc., solid oxide substrates with various porosities can be produced. A paste is applied in the shape of a cathode electrode layer on one surface of the substrate thus obtained as the solid oxide layer, and a paste is applied in the shape of an anode electrode layer on the opposite surface thereof; thereafter, the entire structure is calcined to complete the fabrication of a single solid oxide fuel cell.

The durability of the solid oxide fuel cell can be further increased. In this durability increasing method, a metal mesh is embedded in or fixed to each of the cathode electrode and anode electrode layers of the fuel cell. This metal mesh may also be used as a current collecting electrode of the solid oxide fuel cell to increase the current collecting efficiency. In the case of the embedding method, the material (paste) for forming each layer is applied over the solid oxide substrate, and the metal mesh is embedded in the thus applied material, which is then calcined. In the case of the fixing method, the metal mesh need not be completely embedded in each layer material but may be fixed on a surface of it, followed by sintering.

For the metal mesh, a material that has excellent heat resistance, and that well matches the thermal expansion coefficient of the cathode electrode layer and anode electrode layer to which the metal mesh is to be embedded in or fixed, is preferred for use. Specific examples include a platinum metal and a platinum-containing metal alloy formed in the shape of a mesh. Alternatively, stainless steel of SUS 300 series (304, 316, etc.) or SUS 400 series (430, etc.) may be used; these materials are advantageous in terms of cost.

Instead of using the metal mesh, metal wires may be embedded in or fixed to the anode electrode layer and the cathode electrode layer. The metal wires are formed using the same metal material as that used for the metal mesh, and the number of wires and the configuration of the wire arrangement are not limited to any particular number or configuration. The metal meshes or metal wires embedded in or fixed to the anode electrode layer and the cathode electrode layer serve to reinforce the structure so that the solid oxide substrate, if cracked due to its thermal history, etc., will not disintegrate into pieces; furthermore, the metal meshes or the metal wires act to electrically connect cracked portions.

The above description has been given by dealing with the case where the solid oxide substrate is formed in a porous structure, but it will be recognized that when the solid oxide substrate of the fuel cell is formed in a closely compacted structure, the metal meshes or the metal wires embedded in or fixed to the cathode electrode layer and the anode electrode layer provide particularly effective means to cope with the problem of cracking due to thermal history.

Cracks can also occur in the solid oxide fuel cell because of rapid heating when a gas-fired heater is turned on; however, when the metal meshes or metal wires are embedded or buried at a suitable density in the cathode electrode layer and the anode electrode layer, the metal meshes or metal wires act to conduct the heat evenly over the surface of the fuel cell during rapid heating, thus serving to prevent cracking that could occur due to uneven heat conduction.

The metal mesh or the metal wires may be provided in both the anode electrode layer and the cathode electrode layer or in either one of the layers. Further, the metal mesh and the metal wires may be used in combination. When the metal mesh or the metal wires are embedded at least in the anode electrode layer, then if cracking occurs due to thermal history, the power generation performance of the fuel cell does not degrade and the fuel cell can continue to generate power. As the power generation performance of the solid oxide fuel cell is largely dependent on the effective area of the anode electrode layer as the fuel electrode, the metal mesh or the metal wires should be provided at least in the anode electrode layer.

The thus fabricated solid oxide fuel cell is used as the fuel cell C in the direct-flame exposure type fuel-cell power generating apparatus of the present embodiments. In the present embodiments, the premixed gas combustion flame produced by the gas-fired burner of the combustion device is directly used as the fuel to be supplied to the anode electrode layer 3 formed on the solid oxide fuel cell. The temperature of the heat generated by the premixed gas combustion flame is substantially the same as that of the flame generated in the direct-flame-exposure-type apparatus of FIG. 5, which means that the solid oxide fuel cell can be operated with the premixed gas combustion flame. Accordingly, the flame produced by the combustion at the gas-fired burner is suitable not only as the fuel supply source but also as the driving heat source for the solid oxide fuel cell.

Next, an embodiment of the direct-flame-exposure-type fuel-cell power generating apparatus according to the present invention will be described below. FIG. 1 is a diagram schematically showing the configuration of the power generating apparatus according to the present embodiment. The solid oxide fuel cell used in the power generating apparatus of FIG. 1 is basically the same as that shown in FIG. 5, and is the direct-flame-exposure-type solid oxide fuel cell fabricated in accordance with the above-described method. As in FIG. 5, the flame f1 produced by the gas-fired burner 4 of the flame producing device provides not only the fuel supply source but also the driving heat source for the solid oxide fuel cell.

A mixture gas (premixed gas) is supplied to the gas-fired burner 4 of the flame producing device in the present embodiment. The mixture gas here is supplied from a mixture gas supplying device 5 through a regulator valve 6. The regulator valve 6 regulates the flow rate of the mixture gas to the gas-fired burner 4, and the size of the flame f1 can thus be adjusted. The mixture gas supplying device 5 generates the mixture gas (premixed gas) by mixing a fuel F that can become fuel species for the solid oxide fuel cell by combustion and an oxygen-containing gas, for example, air A, that is necessary for the combustion to take place, and supplies the mixture gas to the gas-fired burner 4. The fuel density can be adjusted by changing the mixture ratio between the fuel F and the air A.

Then, the supply condition of the flame to be supplied to the anode electrode layer 3 of the solid oxide fuel cell C can be changed by adjusting the fuel density in the mixture gas generated in the mixture gas supplying device 5, and also by regulating the flow rate of the mixture gas by adjusting the opening of the regulator valve 6. As the flame supply condition changes, the power generation output of the solid oxide fuel cell C also changes.

Regarding the fact that the power generation output of the solid oxide fuel cell changes depending on the supply condition of the fuel to the fuel cell, the following have been verified by experiment.

a) When the fuel density in the mixture gas supplied to the gas-fired burner 4 is increased, the output of the fuel cell also increases, but when the fuel density exceeds a certain level, the output of the fuel cell does not increase further.

b) When the flow rate of the mixture gas supplied to the gas-fired burner 4 is small, or when the fuel density is low, the flame size becomes small. If the flame is small compared with the area of the anode electrode layer 3, the area that reacts with the flame decreases and the power generation function cannot be effectively exploited.

c) When the flame produced by the gas-fired burner 4 is larger than the anode electrode layer 3, part of the flame spills over into the cathode electrode layer 2 and interferes with the reduction reaction of the oxygen contained in the air. As a result, the power generation output of the fuel cell drops.

As described above, the power generation output of the solid oxide fuel cell changes depending on the supply condition of the fuel to the fuel cell; therefore, when actually operating the solid-oxide fuel-cell power generating apparatus to generate power, conditions for optimizing the supply condition of the flame produced by the gas-fired burner 4 and supplied to the solid oxide fuel cell are set so as to maximize the power generation output of the fuel cell by selecting and adjusting the fuel density and the mixture gas flow rate according to the kind of the fuel used.

The flame supply condition so far described has been optimized so as to maximize the power generation output of the fuel cell by adjusting the fuel density and the mixture gas flow rate according to the kind of the fuel used, but it has been found that, when producing the flame from the mixture gas, if the flame is produced by changing only the flow velocity of the mixture gas discharged from the gas-fired burner 4 while holding the conditions of the kind of fuel, the fuel density, and the mixture gas flow rate unchanged, the power generation output of the direct-flame-exposure-type solid oxide fuel cell increases as the flow velocity increases.

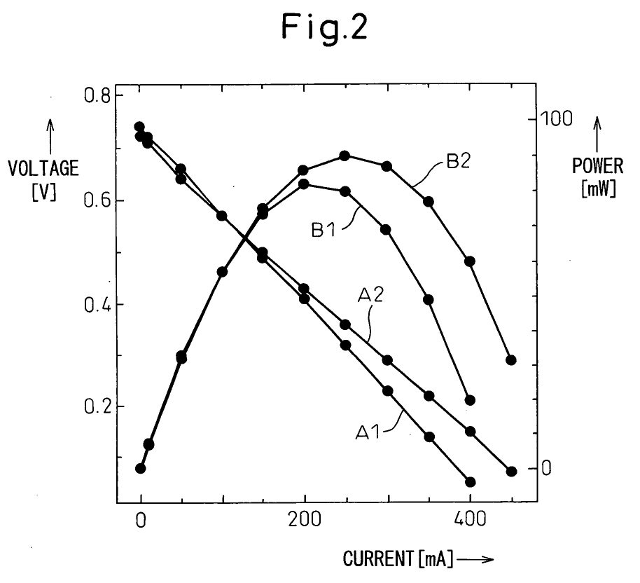

FIG. 2 is a graph of experimental results showing how the output of the solid oxide fuel cell changes when the flow velocity of the mixture gas discharged from the gas-fired burner is changed. In FIG. 2, the horizontal axis represents the current, the vertical axis at the left represents the voltage, and the vertical axis at the right represents the power. The solid oxide fuel cell used in this experiment was fabricated in the following manner.

A solid electrolyte formed from samaria-doped ceria (SDC, Sm_{0.2}Ce_{0.8}O_{1.9} ceramic) was used as the solid oxide substrate. Using a green sheet process, the solid electrolyte was calcined at 1300° C. in the atmosphere to produce a ceramic substrate with a thickness of 200 μm and a diameter of 15 mm. Next, a paste prepared by mixing samaria strontium cobaltite (SSC, Sm_{0.2}Sr_{0.5}Ce_{0.8}O₃) and SDC in proportions of 50% by weight to 50% by weight was applied on one surface of the substrate to print a pattern with a diameter of 13 mm, and the paste was dried.

Further, a paste prepared by mixing nickel oxide containing 8% by mole of lithium in solid solution and SDC in proportions of 60% by weight to 40% by weight, with 5% by weight of rhodium oxide added thereto, was applied on the opposite surface of the substrate to print a pattern with a diameter of 13 mm, and a platinum mesh to which a platinum wire as a lead wire was welded was embedded in each surface. Thereafter, the entire structure was calcined at 1200° C. in the atmosphere to produce a single solid oxide fuel cell.

In the power generation experiment of the solid oxide fuel cell, butane was used as the fuel gas, which was mixed with air to produce the mixture gas, and the setting was made so that the mixture gas was discharged from the gas-fired burner 4 with a fuel gas density of 6.5% and a mixture gas flow rate of 400 ml/min. Here, gas-fired burners, one having an opening inner diameter of 3 mm and the other having an opening inner diameter of 4 mm, were used.

FIG. 2 shows the results of the power generation experiment conducted with the flames produced by these gas-fired burners. In the case of the 4-mm inner diameter gas-fired burner, the voltage changed with the current as shown by a curve A1, and the power changed with the current as shown by a curve B1. On the other hand, in the case of the 3-mm inner diameter gas-fired burner, the voltage changed with the current as shown by a curve A2, and the power changed with the current as shown by a curve B2. From these results, it was verified that the flow velocity of the mixture gas was faster with the 3-mm inner diameter burner than with the 4-mm inner diameter burner, and that an increased power generation output was obtained with the burner that produced the faster mixture gas flow velocity.

The reason that the power generation output of the solid oxide fuel cell increases as the flow velocity of the mixture gas discharged from the gas-fired burner increases is presumably because, when the flow velocity of the mixture gas is high, the speed with which the fuel species contained in the flame is supplied to the anode electrode layer, as well as the speed with which the steam generated at the reaction interface is removed, increases. That is, the substance exchange speed at the reaction interface of the anode electrode layer increases, as a result of which an overvoltage at the anode electrode layer is reduced, and the power generation output of the fuel cell increases.

In view of the above, in the direct-flame-exposure-type fuel-cell power generating apparatus of the present embodiment, an opening adjuster 7 capable of adjusting the burner combustion opening is provided as a means for increasing the flow velocity of the mixture gas being discharged therethrough, and this opening adjuster 7 is attached to the head of the gas-fired burner 4, as shown in FIG. 1. The adjuster 7 has an opening whose inner diameter is smaller than that of the opening in the head of the gas-fired burner 4. The adjuster 7 may be designed to be fitted into the burner head opening, or alternatively, the adjuster 7 may be formed in a constricted shape so that it can be adjusted to an opening of a prescribed size.

When the adjuster for increasing the flow velocity of the mixture gas discharged from the gas-fired burner is provided as in the power generating apparatus of the present embodiment, not only the fuel density and the mixture gas flow rate but also the mixture gas velocity can be adjusted according to the kind of the fuel; this facilitates optimization to maximize the power generation output of the fuel cell, and thus serves to increase the power generation efficiency.

Further, when the flow velocity of the discharged mixture gas is increased, the produced flame is constricted and becomes narrower than when the flow velocity is low. Here, in the early stage of operation, if the solid oxide fuel cell is heated by this constricted flame, thermal shock may occur in the solid oxide fuel cell. Therefore, to mitigate the thermal shock in the early stage of operation, the opening of the burner opening adjuster 7 is increased at the start of the operation, thereby causing the flame to spread out wider and thus making it easier to heat the entire structure of the solid oxide fuel cell. Then, when the solid oxide fuel cell has been heated up to a prescribed temperature, the opening of the adjuster 7 may be reduced so that power can be generated using the flame constricted by increasing the flow velocity of the discharged mixture gas.

As described above, in the direct-flame-exposure-type fuel-cell power generating apparatus of the present embodiment described above, the mixture gas generating device generates the mixture gas by adjusting the fuel density and the flow rate according to the kind of the fuel, and forms a flame using the mixture gas discharged from the gas-fired burner. The supply condition of the flame to the solid oxide fuel cell is adjusted to a condition desirable for the power generating operation of the solid oxide fuel cell so that power can be generated stably.

In the power generating operation of the direct-flame-exposure-type solid oxide fuel cell, when the operation is started, the solid oxide fuel cell is exposed to the flame and the temperature rises rapidly, and when the operation is stopped, the flame is extinguished or removed and the temperature of the solid oxide fuel cell rapidly drops, as a result of which thermal shock is applied to the solid oxide fuel cell; this can cause not only cracks, but also delamination of the anode electrode layer or the cathode electrode layer from the solid oxide substrate because of the difference in thermal expansion coefficient between them. Such phenomena can lead to the degradation of the power generation performance of the solid oxide fuel cell or even to the destruction of the fuel cell.

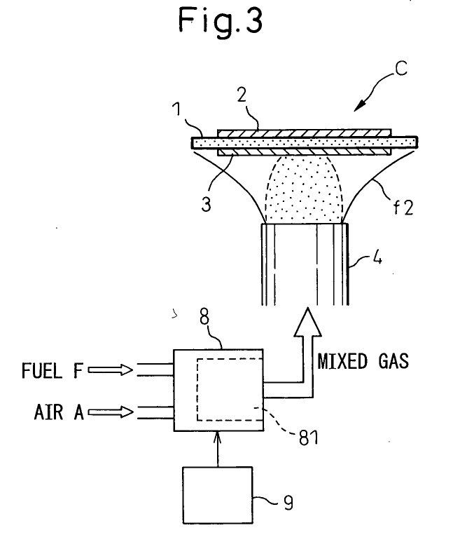

Next, another embodiment of the direct-flame-exposure-type fuel-cell power generating apparatus according to the present invention, which can solve the above problem, will be described below with reference to FIG. 3. The solid oxide fuel cell C used in the power generating apparatus shown in FIG. 3 is the same as that used in the power generating apparatus shown in FIG. 1, and the flame f2 produced by the gas-fired burner 4 is supplied to the anode electrode layer 3 of the solid oxide fuel cell C. The cathode electrode layer 2 is exposed to air and is thus supplied with oxygen contained in the air.

The mixture gas of the fuel gas and air is supplied to the gas-fired burner 4, and is burned at the burner head to form the premixed gas combustion flame f2 which is applied to the solid oxide fuel cell C; the flame f2 thus provides the heat source and fuel supply source for the fuel cell. In the power generating apparatus of this embodiment, the mixture gas to be supplied to the gas-fired burner 4 is produced in a mixture gas adjusting device 8. The mixture gas adjusting device 8 is equipped with a gas buffer tank 81; when generating the mixture gas to be supplied to the gas-fired burner 4, the fuel gas F and air A are first fed into the gas buffer tank 81 where they are mixed together.

In the mixture gas adjusting device 8, the fuel gas F and the air A to be supplied to the gas buffer tank 81 are individually controlled by a control device 9. The control device 9 adjusts the fuel density in the mixture gas to be generated in the gas buffer tank 81, and thus sets the supply condition of the flame f2 differently when starting the power generating operation than when stopping the power generating operation. The user can enter conditions for setting from the control device 9. Here, for the mixture gas generated in the gas buffer tank 81, the amount of the mixture gas to be supplied to the gas-fired burner 4 may be adjusted using a regulator valve, as in the power generating apparatus of FIG. 1.

Next, a description will be given of how the mixture gas adjusting device 8 is controlled by the control device 9. When starting the power generating operation of the fuel cell, first a specified amount of air A is supplied to the gas buffer tank 81. Next, when a steady-state condition is reached, or when a prescribed time has elapsed, the supply of a specified amount of fuel F to the gas buffer tank 81 is started. With this gas supply procedure for the gas buffer tank 81, the fuel density in the mixture gas supplied from the gas buffer tank 81 to the gas-fired burner 4 is initially kept lower than a specified density, but soon increases up to the specified density.

In this gas supply procedure, the size of the flame f2 produced by the gas-fired burner 4 is kept small when the burner is first fired, and the amount of heat it produces is therefore low. For some time after that, the mixture gas at the specified density is supplied, so that the size of the flame f2 increases to a specified size, producing a specified amount of heat. In this way, when the power generating operation is started, the size of the produced flame f2 is initially kept small, and then gradually increases up to the specified size; as a result, the amount of heating of the solid oxide fuel cell C gradually increases, serving to mitigate the thermal shock associated with the heating. This serves to reduce the possibility of the occurrence of cracks, delamination at the interface, etc.

On the other hand, when stopping the power generating operation, first the supply of the fuel gas F is stopped, while continuing to steadily supply the specified amount of air A to the gas buffer tank 81. When the supply of the fuel gas F is stopped, the fuel density in the mixture gas being supplied from the gas buffer tank 81 to the gas-fired burner 4 gradually decreases from the specified density, and soon drops below the combustion limit and down to 0%. In this case, the size of the flame f2 gradually decreases from the specified size, and then the flame goes out. Thereupon, the supply of the air A to the gas buffer tank 81 is stopped.

In this way, when stopping the power generating operation, the size of the flame f2 gradually decreases from the specified size, and therefore the amount of heating of the solid oxide fuel cell C gradually decreases, thus reducing the speed with which the temperature of the solid oxide fuel cell falls; this serves to mitigate the thermal shock associated with the cooling and thereby reduce the possibility of the occurrence of cracks, delamination at the interface, etc. Here, during the power generation, the power generation output of the fuel cell can be changed because the fuel density in the mixture gas to be supplied to the gas-fired burner can be changed by setting conditions from the control device 9.

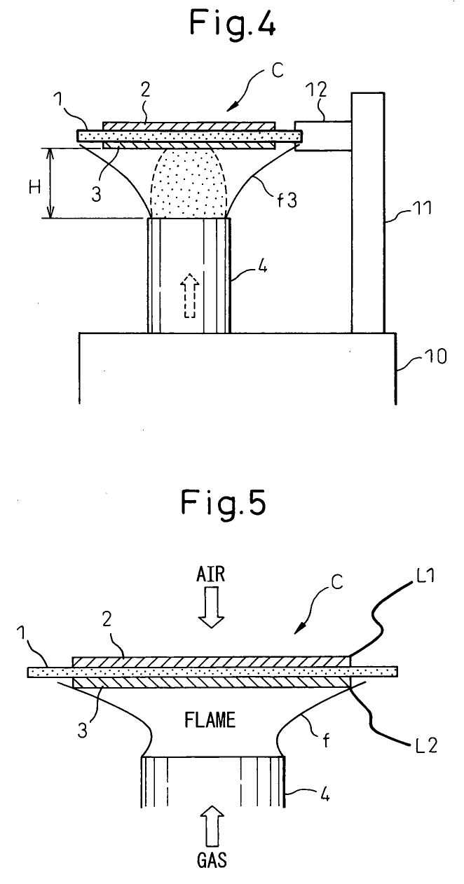

In the direct-flame-exposure-type fuel-cell power generating apparatus according to the above-described embodiments of the present invention, the producing condition of the flame to be applied to the solid oxide fuel cell has been changed by changing the way in which the mixture gas is supplied to the gas-fired burner. Next, an alternative embodiment, of the power generating apparatus according to the present invention, in which the producing condition of the flame to be applied to the solid oxide fuel cell is changed by adjusting the spacing between the gas-fired burner and the solid oxide fuel cell, will be described below with reference to FIG. 4.

In the power generating apparatus according to the embodiments of the present invention shown in FIGS. 1 and 3, the solid oxide fuel cell C has been supported by a supporting means in a fixed position separated from the gas-fired burner by a fixed distance. By contrast, in the example of the power generating apparatus of the alternative embodiment shown in FIG. 4, a supporting device capable of changing the supporting position of the solid oxide fuel cell C is employed, and the producing condition of the flame to be applied to the solid oxide fuel cell is changed by adjusting the spacing relative to the gas-fired burner.

The gas-fired burner 4 is mounted on a base 10, and a post 11 is installed on the base 10. The post 11 is provided with a holder 12 which is movable in vertical directions. The holder 12 grips the solid oxide fuel cell C and holds it in position. The holder 12 can be moved up and down along the post 11 by operating a handle or by a motor-driven means, to adjust the spacing H between the solid oxide fuel cell C and the gas-fired burner 4. The spacing H can also be adjusted by moving the gas-fired burner 4 up and down.

When the spacing H between the solid oxide fuel cell C and the gas-fired burner 4 is changed, for example, when the holder 12 is moved downward to reduce the spacing H, the solid oxide fuel cell C is brought closer to the gas-fired burner 4 and, as a result, the area of the fuel cell exposed to the flame f3 increases even if the size of the flame f3 remains the same as the prescribed size; conversely, when the holder 12 is moved upward to increase the spacing H, the solid oxide fuel cell C moves farther away from the gas-fired burner 4 and, as a result, the area of the fuel cell exposed to the flame f3 decreases.

The spacing H between the solid oxide fuel cell C and the gas-fired burner 4 can be changed as described above; therefore, when the power generating operation is started, the spacing H is initially increased to reduce the area of the solid oxide fuel cell C exposed to the flame f3, and then, the temperature of the solid oxide fuel cell C can be gradually raised by gradually bringing the solid oxide fuel cell C closer to the gas-fired burner 4. With this procedure, the thermal shock that occurs in the solid oxide fuel cell C can be mitigated.

On the other hand, when stopping the power generating operation, the size of the flame f3 to which the solid oxide fuel cell C is exposed remains the same as the prescribed size, but the solid oxide fuel cell C is gradually moved away from the gas-fired burner 4 so that the amount of heating being applied to the solid oxide fuel cell C by the flame is gradually reduced, thus causing the temperature to drop slowly. With this procedure, the thermal shock that occurs in the solid oxide fuel cell C can be mitigated. Here, provisions may be made to automatically adjust the spacing between the solid oxide fuel cell and the gas-fired burner when starting the power generating operation or when stopping the power generating operation.

As described above, in the direct-flame-exposure-type fuel-cell power generating apparatus according to the present invention, the producing conditions of the flame to be applied to the solid oxide fuel cell can be changed by adjusting the flow velocity of the mixture gas supplied to the gas-fired burner or by adjusting the fuel density, or alternatively by adjusting the spacing between the solid oxide fuel cell and the gas-fired burner; accordingly, when starting or stopping the power generating operation of the fuel cell, the thermal shock that occurs in the solid oxide fuel cell can be mitigated, and the possibility of delamination occurring at the interface within the fuel cell can be reduced.

What is claimed is:

1. A direct-flame-exposure-type fuel-cell power generating apparatus comprising:
a solid oxide fuel cell having a solid oxide substrate, a cathode electrode layer formed on one surface of said substrate, and an anode electrode layer formed on a surface of said substrate opposite from said one surface; and
a flame producing device which can supply said anode electrode layer with a flame produced by combustion of a premixed gas, and can adjust a supply condition of said flame, wherein
said solid oxide fuel cell generates power by using oxygen or an oxygen-containing gas supplied to said cathode electrode layer and components of said flame supplied from said flame producing device to said anode electrode layer.

2. A direct-flame-exposure-type fuel-cell power generating apparatus as claimed in claim 1, wherein said flame producing device is connected to a gas generating device which generates said premixed gas from a fuel gas and oxygen or an oxygen-containing gas.

3. A direct-flame-exposure-type fuel-cell power generating apparatus as claimed in claim 1, wherein said flame producing device is equipped with an opening adjuster for adjusting an opening for said gas combustion, and wherein
the flow velocity of said premixed gas to be discharged can be changed by operating said opening adjuster so as to vary said combustion opening.

4. A direct-flame-exposure-type fuel-cell power generating apparatus as claimed in claim 1, wherein said solid oxide fuel cell is supported on a base that can adjust spacing between said solid oxide fuel cell and said flame producing device.

5. A direct-flame-exposure-type fuel-cell power generating apparatus as claimed in claim 2, wherein said gas generating device generates said premixed gas by varying a mixture ratio between said fuel gas and said oxygen-containing gas.

6. A direct-flame-exposure-type fuel-cell power generating apparatus as claimed in claim 5, wherein when said power generation is started, said gas generating device generates said premixed gas by gradually increasing the ratio of said oxygen-containing gas and, when said solid oxide fuel cell has reached a prescribed condition, said gas generating device generates said premixed gas at a prescribed mixture ratio.

7. A direct-flame-exposure-type fuel-cell power generating apparatus as claimed in claim 5, wherein when stopping said power generation, said gas generating device generates said premixed gas by gradually increasing the ratio of said oxygen-containing gas to said fuel gas compared with a prescribed mixture ratio, and stops the supply of said fuel gas.

8. A direct-flame-exposure-type fuel-cell power generating apparatus as claimed in claim 5, wherein said gas generating device is equipped with a gas buffer tank communicating with said flame producing device, and wherein
when said power generation is started, said gas generating device first supplies said oxygen-containing gas in a specified amount to said gas buffer tank and then supplies said fuel gas in a specified amount to said gas buffer tank, thereby supplying said flame producing device first with a premixed gas whose fuel gas density is lower than a specified density and then with a premixed gas at a prescribed mixture ratio.

9. A direct-flame-exposure-type fuel-cell power generating apparatus as claimed in claim 5, wherein said gas generating device is equipped with a gas buffer tank communicating with said flame producing device, and wherein
when stopping said power generation, said gas generating device first stops supply of said fuel gas to said gas buffer tank and, when the density of said fuel gas in said premixed gas supplied to said gas buffer tank has dropped below a combustion limit of said premixed gas, then stops supply of said oxygen-containing gas to said gas buffer tank.
